(19) United States
(12) Patent Application Publication
(10) Pub. No.: US 2007/0141419 A1
(43) Pub. Date: Jun. 21, 2007

(54) Cold start valve structure for fuel cell vehicle

(75) Inventors: Seung-Yong Lee, Hwaseong-si (KR); Seong-Kyun Kim, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/601,405

(22) Filed: Nov. 17, 2006

(30) Foreign Application Priority Data
Dec. 19, 2005 (KR) 10-2005-0125619

(51) Int. Cl. H01M 8/04

(52) U.S. Cl. 429/24; 429/26

(57) ABSTRACT

The present invention provides a cold start valve structure in a fuel cell vehicle, comprising: (a) an inlet pipe having an elliptical valve seat; (b) an outlet pipe arranged to be parallel to the inlet pipe; and (c) a valve body connecting to the inlet pipe and the outlet pipe such that the inlet pipe is in communication with the outlet pipe, the valve body being inclined with respect to the inlet pipe at a predetermined angle.

### CROSS-REFERENCE TO RELATED APPLICATIONS

The present application claims priority of Korean Patent Application Serial Number 10-2005-0125619, filed on Dec. 19, 2005, in the Korean Intellectual Property Office, the disclosure of which is hereby incorporated by reference herein in its entirety.

### FIELD OF THE INVENTION

The present invention relates to a cold start valve for a fuel cell vehicle and, more particularly, to a cold start valve for a fuel cell vehicle, which has an remarkably improved draining ability, thus allowing a driving operation to be performed without consuming additional power, and which does not require a thawing time, thus allowing the fuel cell vehicle to get started immediately, and which ensures stability even at a sub-zero temperature.

### BACKGROUND

As shown in FIG. 1, a conventional cooling system for a fuel cell vehicle includes a first cooling route and a second cooling route. The first cooling route is provided with cooling water which circulates between a radiator 1 and a heat exchanger 2. The second cooling route is provided with cooling water which circulates from a fuel battery stack 3 through a pump 4 and a reservoir tank 5 to the heat exchanger 2.

A heat exchange operation between the cooling water in the fuel battery stack 3 and the cooling water in the first cooling route is performed in the heat exchanger 2, thereby cooling the fuel battery stack 3.

Further, the fuel battery stack 3 and the second cooling route are connected to an additional rapid thaw assembly 6 through drain passages. Further, drain valves 7 comprising solenoid valves are installed in respective drain passages. Thus, when the external temperature falls below zero, the drain valves 7 get opened, thereby draining cooling water from the second cooling route and the fuel battery stack 3 to prevent the cooling water from freezing.

Meanwhile, when the vehicle is re-started, the drain valves 7 get closed, and the cooling water stored in the rapid thaw assembly 6 will be pumped through the pump 4, so that the second cooling route can be filled with the cooling water. In order to complete the filling, the drain valves must be appropriately closed so as to pump the cooling water into the second cooling route using the pump 4.

Surface tension of water causes the frozen water to adhere to the surface of each drain valve 7. As a result, each drain valve 7 may not be operated when the vehicle needs to be re-started. In order to solve the problem, each drain valve 7 is provided with an additional heating means. Generally, a heating wire is wound around each drain valve 7.

However, the conventional cooling system for the fuel cell vehicle is problematic in that because of the additional heating means to thaw the ice of drain valve, substantial amount of thawing time and thawing power is required.

There is thus a need for an improved cold start valve structure that does not require an additional heating means for thawing.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, the present invention provides a cold start valve structure for a fuel cell vehicle comprising: (a) an inlet pipe having an elliptical valve seat; (b) an outlet pipe arranged to be parallel to the inlet pipe; and (c) a valve body connecting to the inlet pipe and the outlet pipe such that the inlet pipe is in communication with the outlet pipe, the valve body being inclined with respect to the inlet pipe at a predetermined angle. Preferably, the valve body may comprise a poppet valve.

In another aspect, motor vehicles are provided that comprise a described valve structure.

It is understood that the term “vehicle” or other similar term as used herein is inclusive of motor vehicles in general such as passenger automobiles, buses, trucks, various commercial vehicles, and the like.

Other aspects of the invention are discussed infra.

### BRIEF DESCRIPTION OF THE DRAWINGS

For a better understanding of the nature and objects of the present invention, reference should be made to the following detailed description with the accompanying drawings, in which:

FIG. 1 illustrates the construction of a conventional cooling system for a fuel cell vehicle; and

FIG. 2 is a sectional view illustrating a cold start valve for a fuel cell vehicle according to the present invention.

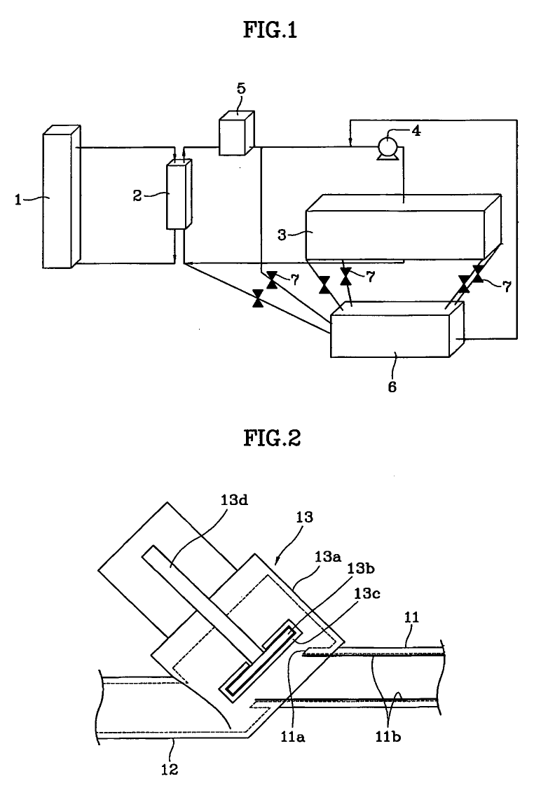

### DETAILED DESCRIPTION OF THE PREFERRED EMBODIMENTS

In one aspect, a cold start valve structure for a fuel cell vehicle is provided, comprising: (a) an inlet pipe having an elliptical valve seat; (b) an outlet pipe arranged to be parallel to the inlet pipe; and (c) a valve body connecting to the inlet pipe and the outlet pipe such that the inlet pipe is in communication with the outlet pipe, the valve body being inclined with respect to the inlet pipe at a predetermined angle.

Preferably, the valve body comprises a poppet valve. In a preferred embodiment of the present invention, poppet valve can be designed to be inclined with respect to inlet pipe at a predetermined angle. Suitably, the predetermined angle for a poppet valve is substantially the same as said predetermined angle for a valve body.

In another preferred embodiment, the poppet valve may be adapted for being able to move so as to open or close the valve seat. As a means for opening and closing the valve seat, a means for generating magnet and a means for generating elastic force can be provided. Preferably, means for generating magnet and means for generating elastic force may be provided in a valve shaft integrally formed with the poppet valve.

Suitably, the poppet valve may be spaced apart from an inner circumferential surface of the valve body and from a circumferential plane of the valve seat.

In another preferred embodiment, the poppet valve can be covered with a cover which is made of a silicone material.

In yet another preferred embodiment, the inlet pipe may have, on its inner circumferential surface, a coating layer to allow a contact angle of a water drop to be 140° or more.

In still another preferred embodiment, both the valve body and the valve seat may have an inclination angle of 35° to 55° relative to the inlet pipe.

In a preferred cold start valve structure of the present invention, the inlet pipe may be designed to be in communication with a fuel battery stack and a cooling-water circulating route. Also the outlet pipe may be designed to be in communication with a rapid thaw assembly.

Herein below, a preferred embodiment of the present invention will be described with reference to the accompanying drawings.

FIG. 2 illustrates a section of a cold start valve for a fuel cell vehicle, according to the present invention. An inlet pipe 11 and an outlet pipe 12 are arranged parallel to each other. The inlet pipe 11 is connected to the second route for cooling water which circulates from the fuel battery stack through the heat exchanger to cool the fuel battery stack. The outlet pipe 12 is connected to the rapid thaw assembly. The two pipes 11 and 12 are connected to communicate with each other via a valve body 13a of a cold start valve 13.

The two pipes can be arranged parallel to each other. Thus, in order to open or close the inlet pipe 11, the outlet of the inlet pipe 11 is cut to have an elliptical shape, thus forming an elliptical valve seat 11a. The valve seat 11a is arranged to be in communication with the valve body 13a. A poppet valve 13b, which comes into close contact with or is separated from the valve seat 11a to close or open the inlet pipe 11, may be installed in the valve body 13a to be inclined at a predetermined angle.

That is, when the cooling water of the second cooling route is drained into the rapid thaw assembly 6 due to a drop in temperature, the poppet valve 13b will be opened, so the cooling water of the second cooling route can be drained through the inlet pipe 11 to the rapid thaw assembly 6. Meanwhile, when the vehicle is re-started, the poppet valve 13b comes into close contact with the valve seat 11a of the inlet pipe 11, thereby closing the inlet pipe 11 to prevent the cooling water from flowing into the second cooling route through the outlet pipe 12 when the cooling water stored in the rapid thaw assembly 6 is supplied to the second cooling route using the pump.

The inclination angle of the poppet valve 13b installed in the valve body 13a may be equal to the inclination angle of the elliptical valve seat 11a provided in the inlet pipe 11. In order to enhance air-tightness when the poppet valve 13b is in close contact with the valve seat 11a, the outer circumferential surface of the poppet valve 13b may be covered with a cover 13c which is made of a silicone material.

Preferably, the poppet valve 13b may be spaced apart from the inner circumferential surface of the valve body 13a in the circumferential direction and in upper and lower directions. Thus, even if cooling water remains in the valve body 13a and freezes, the poppet valve 13b will not adhere to the valve body 13a since the cooling water thaws.

In order to move the poppet valve 13b up and down, a valve shaft 13d can be integrally formed on the poppet valve 13b. Although not shown in the drawing, a magnetic generation means, such as a coil, and a return means, such as a spring, can be provided on the outer circumferential surface of the valve shaft 13d. Thus, for example, when control current is applied from an appropriate control means to the coil, the coil generates magnetic force, thus pulling up the valve shaft 13d and the poppet valve 13b. As a result, the poppet valve 13b will open the inlet pipe 11. Conversely, when the control current breaks, the valve shaft 13d and the poppet valve 13b are returned to their original positions by the return spring, thus closing the inlet pipe 11.

Preferably, the inclination angle of the valve shaft 13d and the inclination angle of the valve seat 11a relative to the inlet pipe 11 are 35 degrees to 55 degrees.

Also preferably, a coating layer 11b may be formed on the inner circumferential surface of the inlet pipe 11, thus preventing the cooling water from remaining on the inner circumferential surface of the inlet pipe 11 in the form of water drops and then freezing. The coating layer 11b may be formed such that the contact angle of the drops of the cooling water is 140 degrees or more to allow the cooling water to be completely drained.

The valve seat 11a provided in the inlet pipe 11 must be manufactured to have a thickness of 0.6 mm or less to minimize the freezing of water drops. Further, the poppet valve 13b must be spaced apart from the valve body 13a and the valve seat 11a by 4 mm or more in order to prevent frozen water drops from causing the poppet valve 13b to adhere to the valve body 13a and the valve seat 11a.

As apparent from the foregoing, according to the present invention, the drops of cooling water which may remain in the inlet pipe after the cooling water has been drained into the rapid thaw assembly can be completely discharged by a coating layer, thereby efficiently preventing the water drops from freezing. Also, the valve structure provided by the present invention eliminates the possibility of the water drops remaining in the valve body that would cause a poppet valve to adhere to a valve body. As a result, no additional heating means for thawing the poppet valve is required, thereby reducing the whole weight of valve structure, decreasing manufacturing cost, preventing the waste of energy, eliminating the thawing period, and ensuring immediate cold start.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A cold start valve structure for a fuel cell vehicle, comprising:
(a) an inlet pipe having an elliptical valve seat;
(b) an outlet pipe arranged to be parallel to the inlet pipe; and
(c) a valve body connected to the inlet pipe and the outlet pipe such that the inlet pipe is in communication with the outlet pipe, the valve body being inclined with respect to the inlet pipe at a predetermined angle.

2. The cold start valve structure of claim 1, wherein said valve body comprises a poppet valve.

3. The cold start valve structure of claim 2, wherein said poppet valve is inclined with respect to the inlet pipe at a predetermined angle.

4. The cold start valve structure of claim 3, wherein said predetermined angle for the poppet valve is substantially the same as said predetermined angle for the valve body.

5. The cold start valve structure of claim 2, wherein said poppet valve is adapted for being able to move so as to open or close the valve seat.

6. The cold start valve structure of claim 5, wherein said movement of the poppet valve is made by a means for generating magnet and a means for generating elastic force.

7. The cold start valve structure of claim 6, wherein said means for generating magnet and means for generating elastic force are integrally formed with the poppet valve.

8. The cold start valve structure of claim 2, wherein said poppet valve is spaced apart from an inner circumferential surface of the valve body and from a circumferential plane of the valve seat.

9. The cold start valve structure of claim 2, wherein said poppet valve is covered with a cover which is made of a silicone material.

10. The cold start valve structure of claim 1, wherein said inlet pipe has on an inner circumferential surface thereof a coating layer to allow a contact angle of a water drop to be 140° or more.

11. The cold start valve structure of claim 1, wherein each of the valve body and the valve seat has an inclination angle of 35° to 55° relative to the inlet pipe.

12. The cold start valve structure of claim 1, wherein said inlet pipe is in communication with a fuel battery stack and a cooling-water circulating route, and said outlet pipe is in communication with a rapid thaw assembly.

13. A vehicle comprising the cold start valve of claim 1.
